(19) United States
(12) Patent Application Publication
(10) Pub. No.: US 2008/0124179 A1
(43) Pub. Date: May 29, 2008

(54) System For Pneumatically Conveying Particulate Material

(76) Inventors: Eric T. Fleckten, Kirkville, NY (US); David M. Gerber, East Syracuse, NY (US); Stephen C. Palin, Jamesville, NY (US); Vernon R. Hudalla, Charlotte, NC (US); Jerry C. VanDerWerff, East Bethel, MN (US)

Correspondence Address: PATENT GROUP 2N;JONES DAY, NORTH POINT, 901 LAKESIDE AVENUE, CLEVELAND, OH, 44114, US

(21) Appl. No.: 11/829,451

(22) Filed: Jul. 27, 2007

Related U.S. Application Data
(60) Provisional application No. 60/861,637, filed on Nov. 29, 2006.

(51) Int. Cl. B65G 53/04

(52) U.S. Cl. 406/50

(57) ABSTRACT

An apparatus for pneumatically conveying particulate material from a container to an application site includes a mill that is operative to reduce the particle size of the material. The apparatus further includes a blower, Pneumatic lines are configured to connect the blower pneumatically with the application site through the container to convey material-laden air from the container to the application site. The pneumatic lines are configured for connection in alternative milling and non-milling arrangements.

### RELATED APPLICATIONS

This application claims the benefit of provisional U.S. Patent Application 60/861,637, filed Nov. 29, 2006, which is incorporated by reference.

### TECHNICAL FIELD

This technology relates to a system for pneumatically conveying particulate material from a storage container to a site at which the material is used.

### BACKGROUND

Exhaust gases may include compounds that can be reduced by applying reactant material prior to emitting the exhaust gases into the atmosphere. A system for applying the reactant material to the exhaust gases includes a blower for pneumatically conveying the material to the application site. The reactant material may be applied in particulate form, and may originally have a particle size that is not optimal for application to the exhaust gases. If so, the material may be milled to reduce the particle size before it is applied to the exhaust gases.

### SUMMARY

An apparatus for pneumatically conveying particulate material from a container to an application site includes a mill that is operative to reduce the particle size of the material. The apparatus further includes a blower. Pneumatic lines are configured to connect the blower pneumatically with the application site through the container to convey material-laden air from the container to the application site. The pneumatic lines are configured for connection in alternative milling and non-milling arrangements.

In a milling arrangement, the pneumatic lines convey material-laden air from the container to the application site along a flow path extending through the mill between the container and the application site. In a non-milling arrangement, the pneumatic lines convey material-laden air from the container to the application site along a flow path bypassing the mill between the container and the application site.

A controller is configured to operate the blower and the mill in a milling mode when the pneumatic lines are in a milling arrangement, and to operate the blower and the mill in a non-milling mode when the pneumatic lines are in a non-milling arrangement. Preferably, the blower, the mill, and the controller are mounted as fixtures on a vehicle for transportation to the location of the container and the application site, and for operation in place on the vehicle at the location of the container and the application site.

The mill is preferably configured to receive a material-laden air stream and a material-free air stream, and to combine the material-laden and material-free air streams for discharge together from the mill.

Summarized differently, an apparatus for pneumatically conveying particulate material from a container to an application site includes a mill, a blower, and pneumatic lines configured to interconnect the mill and the blower with the container and the application site. The mill and the blower are mounted as fixtures on a vehicle. The mill and the blower are thus transportable relative to the container and the application site with the vehicle, and are operatively connectable pneumatically with the container and the application site in place on the vehicle.

### BRIEF DESCRIPTION OF TEE DRAWINGS

FIG. 1 is a schematic view of a container of particulate material, an application site for the particulate material, and parts of a system for conveying the particulate material pneumatically from the container to the application site.

FIG. 2 is a schematic view showing the system pneumatically interconnected with the container and the application site in a first arrangement.

FIG. 3 is a schematic view showing the system pneumatically interconnected with the container and the application site in an alternative arrangement.

FIG. 4 is a schematic view similar to FIG. 3 showing the system pneumatically interconnected with the container and the application site in another alternative arrangement.

### DETAILED DESCRIPTION

The apparatus shown in the drawings has parts that are examples of the elements recited in the claims. The following description thus includes examples of how a person of ordinary skill in the art can make and use the claimed invention. It is presented here to meet the statutory requirements of written description enablement, and best mode without imposing limitations that are not recited in the claims.

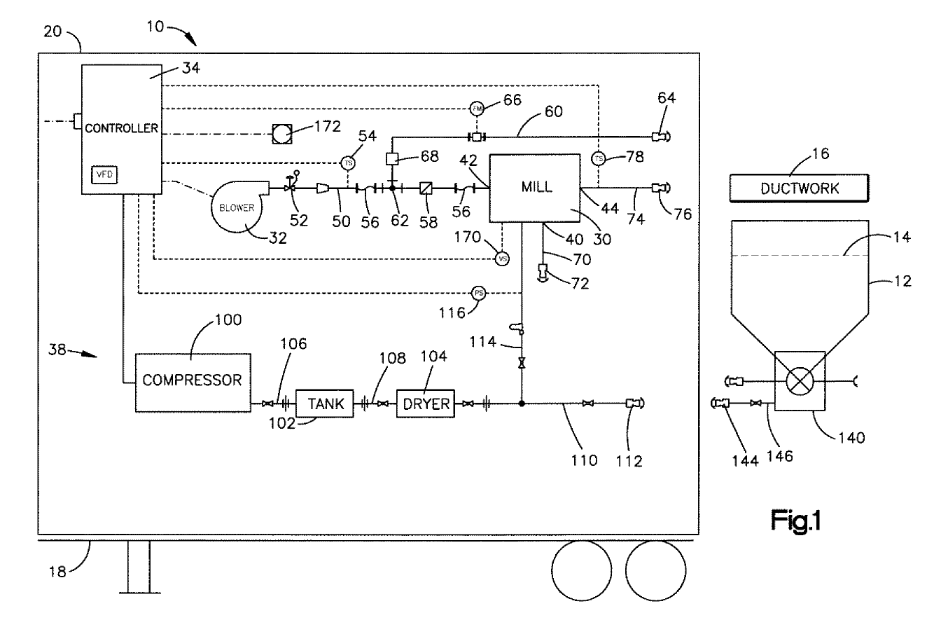

FIG. 1 shows parts of a system 10 for pneumatically conveying particulate material. Also shown in FIG. 1 is a container 12 with a stored quantity of particulate material 14, and a site 16 at which the particulate material 14 is to be applied. In the illustrated example, the particulate material 14 is sorbent for reducing emissions of exhaust compounds such as sulfur dioxide, sulfur trioxide, nitrogen oxide, mercury, and hydrochloric acid. Accordingly, the application site 16 in the illustrated example is ductwork for conveying flue gas to the exhaust stack in a plant that produces such exhaust compounds. The system 1O, in the preferred embodiment, includes a vehicle 18 upon which parts of the system 10 are mounted as fixtures for transportation relative to the container 12 and the plant at which the ductwork 16 is located.

The vehicle 18 shown in the drawings is a wheeled trailer with an enclosure 20. The parts of the system 10 that are mounted on the trailer 18 include a mill 30, a blower 32, and a controller 34 configured to operate the mill 30 and the blower 32. Additional system components define a purge air subsystem 38.

The mill 30 has two inlets 40 and 42 and one outlet 44. The first inlet 40 is for an air stream that carries the particulate material 14 to be milled. The second inlet 42 is for an air stream that is free of particulate material 14. The mill 30 is configured to combine the two air streams to exit the mill 30 together at the outlet 44. This enables the outlet 44 of the mill 30 to discharge an air flow that exceeds the material-laden air flow capacity of the mill 30.

The output of the blower 32 is transmitted to the mill 30 and further throughout the system 10 by pneumatic lines. These include a blower output line 50 extending directly from the blower 32 to the second mill inlet 42. A pressure sensor 52 and a temperature sensor 54, both of which are monitored by the controller 34, are operatively connected in the blower output line 50. Flex hose sections 56 are included in the blower output line 50 as needed for strain relief. Also included in the blower output line 50 is a manual butterfly valve 58.

A pneumatic bypass line 60 diverges from the blower output line 50 at a tee 62 upstream of the mill 30. The bypass line 60 has a connector 64 at its free end. A flow meter 66 is connected in the bypass line 60, and another manual butterfly valve 68 is connected between the flow meter 66 and the tee 62. An inlet line 70 for the mill 30 has a connector 72 at its free end. An outlet line 74 for the mill 30 also has a connector 76 at its free end. Another temperature sensor 78 is operatively connected in the mill outlet line 74.

The purge air subsystem 38 includes a compressor 100, a dryer 102, and an air storage tank 104, all of which are fixtures on the trailer 18. A first purge air line 106 transmits the compressor output to the dryer 102. A second purge air line 108 transmits compressed air from the dryer 102 to the tank 104. A dryer output line 110 extends to a connector 112, and a bypass line 114 extends from the dryer output line 110 to the mill 30. Regulators 116 and 118 in these lines 110 and 114 reduce the air pressure from the storage level to appropriate lower levels. A pressure sensor 120 in the bypass line 114 is monitored by the controller 34.

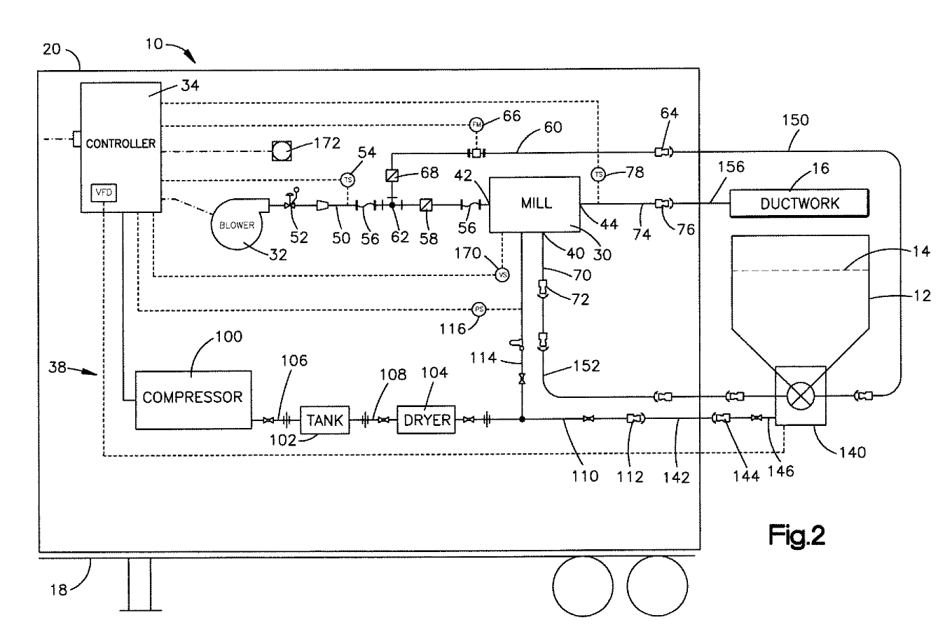

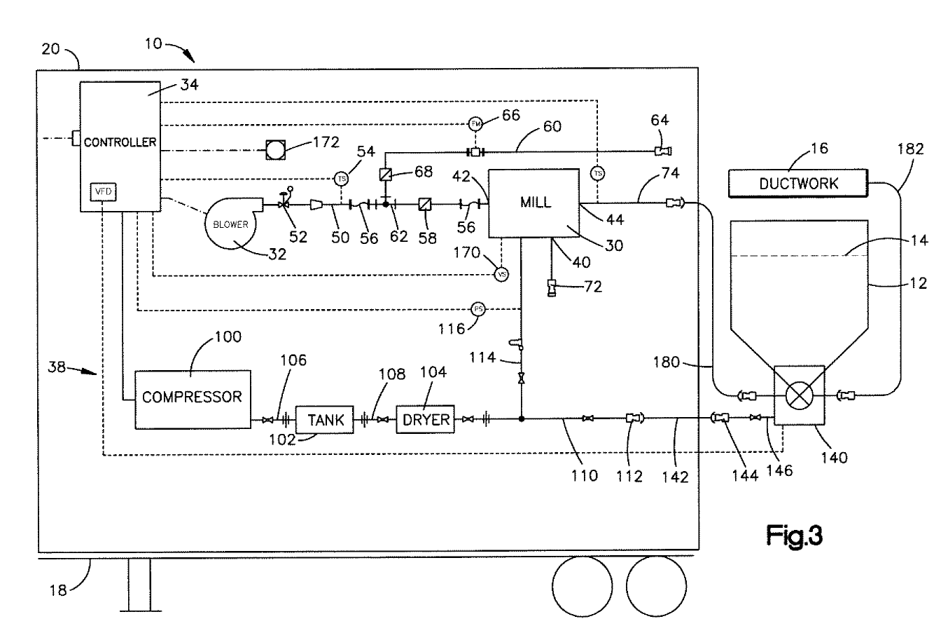

As thus far described, the various components of the system 10 are operative in the positions and configurations in which they are mounted on the trailer 18. Additional components of the system 10 are configured to interconnect the trailer-mounted components with the container 12 and the ductwork 16. The interconnection of the system 10 with the container 12 and the ductwork 16 can be accomplished in alternative arrangements. When interconnected in the arrangement of FIG. 2, the system 10 operates in a milling mode in which the sorbent material 14 is directed through the mill 30 for a reduction in particle size prior to application at the ductwork 16. When interconnected in the arrangement of FIG. 3, the system 10 operates in a non-milling mode in which the sorbent material 14 is conveyed from the container 12 to the ductwork 16 without passing through the mill 30.

Specifically, in the arrangement of FIG. 2 the controller 34 is operatively interconnected with a rotary air lock 140 at the container 12. The purge air subsystem 38 is extended to the air lock 140 by a purge air line 142. That line 142 extends from the connector 112 on the dryer output line 11O to a connector 144 on a line 146 into the bearings in the air lock 140.

As further shown in FIG. 2, the bypass line 60 that diverges from the blower output line 50 is connected to the air lock 140 by an additional bypass line 150. A feed line 152 connects the air lock 140 with the mill inlet line 70. Although the additional bypass line 150 is shown as a unitary pneumatic line, and the feed line 152 is shown in multiple sections, these differences are presented merely to illustrate that any suitable combination of pneumatic lines, sections, and connectors may be employed to establish these and other pneumatic connections throughout the system 10. With the system 10 connected pneumatically with the container 12 of sorbent material 14 in this manner, a delivery line 156 is added to extend the mill outlet line 74 to the ductwork 16.

Operation of the system 10 in the milling mode is best described with reference to the various pneumatic lines that are located upstream and downstream of the mill 30 in the arrangement of FIG. 2. Upstream of the mill 30, the valves 58 and 68 in the blower output line 50 and the bypass line 60 are both open. The blower output line 50 conveys a sorbent-free air stream from the blower 32 to the second mill inlet 42. The bypass lines 60 and 150 convey a sorbent-free air stream from the blower 32 to the air lock 140 at the container 12. The feed line 152 and the mill inlet line 70 convey a sorbent-laden air stream from the air lock 140 to the first mill inlet 40 under the influence of the blower output that the bypass lines 60 and 150 transmit to the air lock 140. This enables the particle size of the sorbent 14 to be reduced in the mill 32. Downstream of the mill 30, the outlet line 76 and the delivery line 156 convey a sorbent-laden air stream to the ductwork 16 under the influence of the blower output that the upstream lines 50, 60, 150, 152 and 70 transmit to the mill 30. Since that air flow can exceed the material-laden air flow capacity of the mill 30, it can be great enough to ensure that the milled sorbent 14 is conveyed fully from the mill 30 to the ductwork 16.

In the milling mode of operation, the mill 30 breaks apart the sorbent 14 by forcing the particles to impact rotating steel pins. The controller 34 monitors a vibration sensor 170 at the mill 30. If the sensed vibrations exceed tolerances, the controller 34 responds by cutting power to the mill 30 and actuating an alarm 172.

The controller 34 also monitors the flow meter 66 in the bypass line 60. Based on laboratory testing, the mill 30 requires a specific air flow to produce its smallest median particle size. The flow meter 66 measures the rate at which the sorbent-free air stream flows to the air lock 140 to drive the sorbent-laden air stream from the air lock 140 to the mill 30. If the flow rate decreases below a pre-determined rate necessary to maintain a dilute phase condition in the lines 152 and 70 carrying the sorbent-laden air stream, the sorbent 14 can drop out of the air flow and plugging can occur. If the meter 66 indicates such a decrease, the controller 34 responds by cutting power to the air lock 140 and actuating the alarm 172. The air flow rate can then be corrected by manual operation of the butterfly valves 58 and 68.

The controller 34 monitors the pressure and temperature sensors 52, 54 and 78 in the blower output line 50 in a similar manner. If the pressure drops below a specified minimum, or if the temperature exceeds a specified maximum, the controller 34 responds by cutting power to the air lock 140 to interrupt the flow of sorbent 14 to the mill 30. Depending on the particular sorbent 14 utilized, high temperatures can have a negative impact on the efficiency by which the sorbent 14 reduces emissions.

When the system 10 is reconfigured in the arrangement of FIG. 3, the valve 68 in the bypass line 60 is closed, The additional bypass line 150, the feed line 152, and the delivery line 156 of FIG. 2 are omitted. A downstream connector line 180 is added to connect the mill outlet line 74 with the air lock 140. An alternative delivery line 182 is added to connect the air lock 140 with the ductwork 16.

In the non-milling mode of operation, the blower output line 50 upstream of the mill 30 conveys a sorbent-free air stream from the blower 30 to the second mill inlet 42. Downstream of the mill 30, the outlet line 74 and the connector line ISO convey a sorbent-free air stream from the mill outlet 44 to the air lock 140. The delivery line 182 conveys a sorbent-laden air stream from the air lock 140 to the ductwork 16 under the influence of the blower output transmitted to the air lock 140 by the blower output line 50, the mill outlet line 74, and the connector line 180. The non-milling mode of operation thus conveys the sorbent 14 from the container 12 to the ductwork 16 without passing the sorbent 14 through the mill 30.

The purge air subsystem 38 is configured to operate in both the milling and non-milling modes. To ensure that the sorbent 14 does not flow into the bearings in the mill 30, purge air is blown into the bearings through the purge bypass line 14 at a pressure greater than the conveying air entering the mill 30. If this pressure drops below the maximum pressure of the conveying air entering the mill 30, the controller 34 responds by cutting power to the mill 30 and actuating the alarm 172. In order to ensure that the sorbent 14 does not flow into the bearings in the rotary air lock 140, the bearing line 142 conveys purge air to those bearings at a pressure greater than the pressure of the conveying air transmitted on the bypass line 150. If the pressure in the bearings drops below the maximum pressure of the conveying air passing through the air lock 140, the controller 34 cuts power to the air lock 140 and sounds the alarm 172.

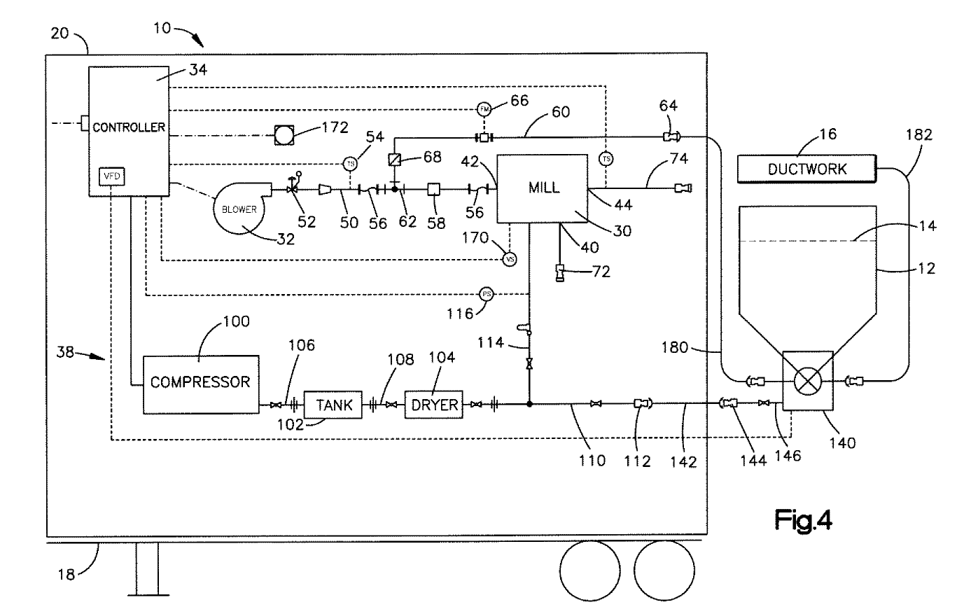

Another non-milling arrangement is shown in FIG. 4. In this arrangement, the valve 58 in the blower output line 50 is closed. The sorbent-free air stream from the blower 32 bypasses the mill 30, and the downstream connector line 180 receives the sorbent-free air stream from the bypass line 60 instead of the mill outlet line 74. The system 10 otherwise operates in a non-milling mode as described for the arrangement of FIG. 3.

The patentable scope of the invention is defined by the claims, and may include other examples of how the invention can be made and used. Such other examples, which may be available either before or after the application filing date, are intended to be within the scope of the claims if they have structural elements that do not differ from the literal language of the claims, or if they have equivalent structural elements with insubstantial differences from the literal language of the claims.

What is claimed is:

1. An apparatus for pneumatically conveying particulate material from a container to an application site, the apparatus comprising:
a mill that is operative to reduce the particle size of the material;
a blower; and
pneumatic lines configured to connect the blower pneumatically with the application site through the container to convey material-laden air from the container to the application site, the pneumatic lines being configured for connection in alternative arrangements, including:
a) a milling arrangement to convey material-laden air from the container to the application site along a flow path extending through the mill between the container and the application site, and
b) a non-milling arrangement to convey material-laden air from the container to the application site along a flow path bypassing the mill between the container and the application site.

2. An apparatus as defined in claim I wherein the mill is configured to receive a material-laden air stream and a material-free air stream when the pneumatic lines are in the milling arrangement, and to combine the material-laden and material-free airstreams for discharge together from the mill.

3. An apparatus as defined in claim 2 wherein the pneumatic lines in the non-milling arrangement define a pneumatic flow path extending through the mill between the blower and the container to convey material-free air to the container through the mill.

4. An apparatus as defined in claim 1 wherein the pneumatic lines in the non-milling arrangement define a pneumatic flow path bypassing the mill between the blower and the container to convey material-free air directly from the blower to the container.

5. An apparatus as defined in claim I further comprising a controller configured to operate the mill and the blower in a milling mode when the pneumatic lines are in the milling arrangement, and to operate the mill and the blower in a non-milling mode when the pneumatic lines are in the non-milling arrangement.

6. An apparatus as defined in claim 1 further comprising a vehicle on which the mill and the blower are mounted for transportation relative to the container and the application site, and for operation in place on the vehicle.

7. An apparatus for pneumatically conveying particulate material from a container to an application site, the apparatus comprising:
a mill that is operative to reduce the particle size of the material;
a blower;
pneumatic lines configured to interconnect the blower and the mill pneumatically with the container and the application site; and
a vehicle on which the blower and the mill are mounted for transportation relative to the container and the application site, and upon which the blower and the mill are operatively connectable pneumatically with the container and the application site through the pneumatic lines.

8. An apparatus as defined in claim 7 wherein the pneumatic lines are configured to interconnect the blower pneumatically with the container and the application site in a milling arrangement in which the pneumatic lines communicate the container with the application site along a flow path extending through the mill to convey material-laden air from the container to the mills and alternatively in a non-milling arrangement in which the pneumatic lines communicate the container with the application site along a flow path bypassing the mill to convey material-laden air directly from the container to the application site.

9. An apparatus as defined in claim 8 wherein the mill is configured to receive a material-laden air stream and a material-free air stream and to combine the material-laden and material-free airstreams for discharge together from the mill.

10. An apparatus as defined in claim 7 further comprising a controller that is mounted on the vehicle and configured to operate the blower and the mill in place on the vehicle.
